(19) United States
(12) Patent Application Publication
(10) Pub. No.: US 2026/0097678 A1
(43) Pub. Date: Apr. 9, 2026

(54) AUTOMATIC COMMISSIONING OF CHARGING STATIONS

(71) Applicant: LIIKENNEVIRTA OY / VIRTA LTD, Helsinki (FI)

(72) Inventor: Jussi AHTIKARI, Helsinki (FI)

(73) Assignee: LIIKENNEVIRTA OY / VIRTA LTD, Helsinki (FI)

(21) Appl. No.: 19/115,061

(22) PCT Filed: Sep. 15, 2023
(86) PCT No.: PCT/FI2023/050524

§ 371 Date: Mar. 25, 2025

(30) Foreign Application Priority Data
Sep. 26, 2022 (FI) 20225834

(51) Int. Cl. B60L 53/65; B60L 53/66; B60L 53/68

(52) U.S. Cl. CPC B60L 53/65; B60L 53/66; B60L 53/68

(57) ABSTRACT

Example embodiments provide automatic commissioning of charging stations. An apparatus (700) is configured to enable automatic commissioning of one or more charging stations based on a received identifier and performing configuration operations associated with the identifier. An apparatus, a method, and a computer program are disclosed.

### TECHNICAL FIELD

The present application generally relates to electric vehicle charging stations. In particular, some example embodiments of the present application relate to commissioning of electric vehicle charging stations.

### BACKGROUND

When new charging stations are deployed, multiple configurations and settings need to be done for a charging station. This process is called commissioning. Commissioning tasks may be time-consuming and complicated. Hence, there is a need to alleviate at least some of the drawbacks.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may enable more efficient commissioning processes. The time required for setting up a new charging station may be decreased, and customer experience may be improved when the user may only need to identify themselves at the new charging station when using it for the first time in order to have needed settings ready at the charging station.

According to a first aspect, an apparatus for commissioning of charging stations is provided. The apparatus comprises at least one processor; and at least one memory comprising instructions which, when executed by the at least one processor, cause the apparatus to store a plurality of commissioning groups, each commissioning group comprising information on different settings for configuring at least one of a charging station, a charging station management system or one or more third party systems associated with the charging station and a unique list of identifiers; receive an authorization request from a charging station, the authorization request comprising an identifier of the charging station and an identifier associated to a user; determine if the identifier of the charging station belongs to the unique list of identifiers of any of the plurality of commissioning groups; determine if the identifier associated to the user belongs to the unique list of identifiers of any of the plurality of commissioning groups; determine, based on at least one commissioning group comprising the identifier of the charging station or the identifier associated to the user, which settings are to be performed and where; and configure at least one of the charging station which sent the authorization request, the charging station management system or the one or more third party systems according to the determined settings.

In an embodiment, the least one memory further comprises instructions which, when executed by the at least one processor, cause the apparatus to store at least one sub-commissioning group, wherein each sub-commissioning group is associated to one commissioning group and comprises further settings for configuring at least one of the charging station, the charging station management system or the one or more third party systems and at least one identifier from the unique list of identifiers of the commissioning group; activate the at least one sub-commissioning group for a predetermined time period after the configuration according to the associated commissioning group has been performed by setting an authorization mode of the charging station which sent the authorization request to public for the predetermined time period; receive an authorization request within the predetermined time period comprising the identifier of the charging station and another identifier associated to a user; and configure at least one of the charging station which sent the authorization message, the charging station management system or the one or more third party systems according to the settings of the at least one sub-commissioning group.

In an embodiment, in addition or alternatively, the least one memory further comprises instructions which, when executed by the at least one processor, cause the apparatus to determine if the charging station which sent the authorization request has been previously configured according to the settings of at least one associated commissioning group; determine if the at least one commissioning group is associated to at least one sub-commissioning group; determine if the at least one sub-commissioning group has been previously activated and that the predetermined time period has elapsed; and cause an authorization process to continue based on the authorization request if the configurations based on at least one of the commissioning group or the sub-commissioning group have been already done.

In an embodiment, in addition or alternatively, the one or more third party systems comprise at least one of a management system of a leasing company or an internet connectivity solution management system.

In an embodiment, in addition or alternatively, the unique list of identifiers comprises at least one identifier associated with a user and the settings of the respective commissioning group or sub-commissioning group comprise parameters for at least one user-specific setting at least one of at the charging station, the charging station management system or the one or more third party systems.

In an embodiment, in addition or alternatively, the unique list of identifiers comprises an identifier of at least one charging station and the settings of the respective commissioning group or sub-commissioning group comprise parameters to at least one of set a maximum current of the charging station, set a heartbeat interval of the charging station, update a data communication plan of an internet connectivity solution at the charging station, set the authorization mode at the charging station to public or set the authorization mode at the charging station to private.

In an embodiment, in addition or alternatively, the at least one identifier associated to a user of at least one sub-commissioning group is associated with maintenance personnel and the settings comprise parameters to at least one of set an authorization mode at a charging station to public, set the authorization mode at a charging station to private, set a logging level of a charging station to a debug level for maintenance or set the logging level of a charging station to a normal level; and wherein the at least one memory further comprises instructions which, when executed by the processor, cause the apparatus to receive an authorization request from the charging station after the predetermined time period has elapsed, the authorization request comprising the identifier of the charging station and an identifier associated to a user; determine if the identifier associated with the user is comprised in the sub-commissioning group associated with the maintenance personnel; and configure the charging station which sent the authorization request and the charging station management system according to the settings of the sub-commissioning group.

According to a second aspect, a method for commissioning of a charging station is provided. The method comprises storing a plurality of commissioning groups, each commissioning group comprising information on different settings for configuring at least one of a charging station, a charging station management system or one or more third party systems associated with the charging station and a unique list of identifiers; receiving an authorization request from a charging station, the authorization request comprising an identifier of the charging station and an identifier associated to a user; determining if the identifier of the charging station belongs to the unique list of identifiers of any of the plurality of commissioning groups; determining if the identifier associated to the user belongs to the unique list of identifiers of any of the plurality of commissioning groups; determining, based on the at least one commissioning group comprising the identifier of the charging station or the identifier associated to the user, which settings are to be performed and where; and configuring at least one of the charging station which sent the authorization request, the charging station management system or the one or more third party systems according to the determined settings.

In an embodiment, the method further comprises storing at least one sub-commissioning group, wherein each sub-commissioning group is associated to one commissioning group and comprises further settings for configuring at least one of the charging station, the charging station management system or the one or more third party systems and at least one identifier from the unique list of identifiers; activating a configuration according to the at least one sub-commissioning group for a predetermined time period after the configuration according to the associated commissioning group has been performed by setting an authorization mode of the charging station which sent the authorization request to public for the predetermined time period; receiving an authorization request from the charging station within the predetermined time period comprising the identifier of the charging station and another identifier associated to a user; and configuring at least one of the charging station which sent the authorization message, the charging station management system or the one or more third party systems according to the settings of the at least one sub-commissioning group.

In an embodiment, in addition or alternatively, the method comprises determining if the charging station which sent the authorization request has been previously configured according to the settings of at least one associated commissioning group; determining if the at least one commissioning group is associated to at least one sub-commissioning group; determining if the at least one sub-commissioning group has been previously activated and that the predetermined time period has elapsed; and causing an authorization process to continue based on the authorization request if the configurations based on at least one of the commissioning group or the sub-commissioning group have been already done.

In an embodiment, in addition or alternatively, the unique list of identifiers comprises at least one identifier associated with a user and the settings of the respective commissioning group or sub-commissioning group comprise parameters for at least one user-specific setting at least one of at the charging station, the charging station management system or the one or more third party systems.

In an embodiment, in addition or alternatively, the unique list of identifiers comprises at least one identifier of a charging station and the settings of the respective commissioning group or sub-commissioning group comprise parameters to at least one of set a maximum current of the charging station, set a heartbeat interval of the charging station, update a data communication plan of an internet connectivity solution at the charging station, set the authorization mode at the charging station to public or set the authorization mode at the charging station to private.

In an embodiment, in addition or alternatively, the at least one identifier associated with a user of at least one sub-commissioning group is associated with maintenance personnel and the settings comprise parameters to at least one of set the authorization mode at a charging station to public, set the authorization mode at a charging station to private, set a logging level of a charging station to a debug level for maintenance or set a logging level of a charging station to a normal level; and the method further comprises receiving an authorization request from the charging station after the predetermined time period has elapsed, the authorization request comprising the identifier of the charging station and an identifier associated to a user; determining if the identifier associated with the user is comprised in the sub-commissioning group associated with the maintenance personnel; and configuring the charging station which sent the authorization request and the charging station management system according to the settings of the sub-commissioning group.

According to a third aspect, a computer program product comprising instructions which, when executed by a computer, cause the computer to carry out the method according to the second aspect is provided.

According to a fourth aspect, a computer readable medium comprising instructions which, when executed by a computer, cause the computer to carry out the method according to the second aspect is provided.

Many of the attendant features will be more readily appreciated as they become better understood by reference to the following detailed description considered in connection with the accompanying drawings.

### BRIEF DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example of operations to be performed for commissioning a new charging station at an installation site from a user perspective according to an example embodiment;

FIG. 2 illustrates an example of data stored for commissioning of a new charging station according to an example embodiment;

FIG. 3 illustrates an example of a method for charging station commissioning according to an example embodiment;

FIG. 4 illustrates an example of data stored for a sub-commissioning process according to an example embodiment;

FIG. 5 illustrates an example of sub-commissioning configurations according to an example embodiment;

FIG. 6 illustrates an example of a method for sub-commissioning of charging stations according to an example embodiment;

FIG. 7 illustrates an example of an apparatus configured to practice at least one example embodiment.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

In general, charging stations (CS) are used to charge electric vehicles (EV). Charging stations may be connected to a charging station management system (CSMS) with different protocols, such as an OCPP-protocol. EV drivers own electric vehicles (EV) and charge their EVs on charging stations. An EV driver may be also referred to as a user. Charging point owners (CPO) own the charging stations.

EV drivers may need to authorize themselves before they can start charging at a charging station. EV drivers can be authorized, for example, via a RFID-card or a mobile application. Technically, each EV driver may be identified with a unique identifier, and when the EV driver shows the RFID-card or uses the mobile application to start charging, the charging station may send the unique identifier to the CSMS. During the authorization process, the charging station may ask from the CSMS if charging on a charging station is allowed to be started based on a certain unique identifier. The CSMS then checks to which (if any) EV driver the unique identifier belongs and approves or rejects the charge attempt.

When a new charging station is shipped from a factory, the charging station may comprise some factory settings. However, before the charging station is put to operation, there may be multiple different kinds of configurations and settings that may need to be done or changed for the charging station. As an example, with a new charging station for home use, the charging station may need to be linked with the right EV driver (e.g., home owner), so that the EV driver may manage the charging station with their mobile application, for example. In addition, certain configurations like access settings and power limits may need to be set for the charging station since the charging station is meant for home use. Further, the home owner may want to enable some features, such as a plug & charge feature. Also, settings of a SIM-card may require adjustments at the charging station, such as updating a data communication plan once the SIM-card is taken into use. There may also be other commissioning operations that need to be done depending on the charging station, users of the charging station, or a location of the charging station.

An objective is to enable performing the commissioning as easy and automatically as possible. An example embodiment enables CPOs (in case of public charging) and users (in case of home charging) to set up charging stations with correct and desired configurations more efficiently when a charging station is received with some initial settings, such as with factory settings. An apparatus may be configured to perform commissioning of charging stations more automatically such that less manual work may be required from at least one of a party that gets the charging station or an operator that manages the charging station.

A charging station may be received with preliminary configurations. The preliminary configurations may comprise, for example, an internet connectivity solution. The internet connectivity solution may comprise, for example, a SIM-card. Alternatively, or in addition, the internet connectivity solution may comprise for example a fixed LAN-cable or a home Wi-Fi. Based on the internet connectivity solution, an internet connectivity may be set up. Further, the charging station may be connected to a CSMS. Technically, an endpoint, such as a URL which points to the correct CSMS, may be configured for internal settings of the charging station. The configuration may be done at the factory before the charging station is shipped to the user, for example. However, because different use cases, like home use or public use of the charging station, may require quite different settings, commissioning based on further configurations may be needed when the new charging station is deployed.

Charging stations for public use, also known as public charging stations, may have a lot of people using them and a lot of charging events during one day. Hence, for example the following settings may need to be done for the public charging stations. The public charging stations may need to be available to all the people using a public charging station network, which may be shown on a map of a mobile application. Since there is a lot of usage on the public charging stations, the SIM-card of the public charging station may need a bigger data plan (for example 100MB) for connectivity, compared to charging stations used at home, also known as home charging stations.

The home charging stations may have only one person, or household, using a single charging station. Hence, for example the following settings may need to be configured for the home charging station. Some features, such as plug & charge, may be enabled at the home charging station. A plug & charge feature may enable more convenient charging at a frequently used charging station, for example, for a single user or a household. A plug & charge feature may allow automated communication and billing processes between an electric vehicle and a charging station without a need for external identification. A plug & charge feature may refer to an automatic authorization process based on charging equipment plugged in to a charging station. A charging cable is an example of charging equipment. When the plug & charge feature is enabled, the user may not need to use a mobile application or a RFID-card to initiate every charging event, for example, at their home. When the plug & charge feature is enabled at a charging station, charging may be initiated simply by connecting charging equipment of an electric vehicle to the charging station. A plug & charge feature may be based on, for example, standard ISO15118. A plug & charge feature may comprise preset information for identification, for example, with a charging cable or via Wi-Fi, enabling the charging station and a back-end service (e.g., CSMS) to identify an EV and its owner when the EV is plugged in to the charging station. The preset information may comprise an identifier associated to a user or an EV. In addition to the plug & charge feature, or alternatively, any other automatic authorization process may be enabled at a charging station based on one or more preset parameters. Further, a smaller data communication plan on the SIM-card may be sufficient compared to the public charging stations, because there may be a lot fewer charging transactions.

Home charging may refer to charging EVs on charging stations which are in private use of the EV drivers. There may be at least two types of home locations, private houses and apartment buildings. In case of private houses, only one person or members of one household may use the charging station. Access to the charging station may be physically controlled such that only (a) certain person(s) will have physical access to the charging station. In case of apartment buildings and similar locations, several people may be using the same charging stations at the location. Physical access to the charging stations may not be controlled. To prevent other people than residents of the apartment building from charging at the respective charging station, the EV drivers may be authorized at the charging station to start charging. Therefore, when an EV driver plugs in an EV at the charging station, it may be checked if this EV driver is allowed to charge at the charging station or not. Both types of home charging have a different commissioning process due to the differences in use cases and preferences.

When a new home charging station is taken into use, an operator may need to create a QR-code or similar identification for the home charging station and ship the created identification to the user with the home charging station. Further, the operator may need to enable the SIM-card or similar internet connectivity solution for the home charging station and manually configure a correct data communication plan for the SIM-card. The operator may further need to manually set up access settings for the home charging station to configure who is allowed to charge at the respective charging station. In addition to the work which may need to be done by the operator, the user may need to use a mobile application to scan the QR code or enter an identification of the home charging station provided by the operator to link the home charging station to an account of the user. In addition, the user may be required to do different kinds of settings on the mobile application to configure various features, such as plug & charge and access settings. To carry out the commissioning process described above, the operator and the user may need to read and follow up to ten pages of instructions and perform a lot of manual work.

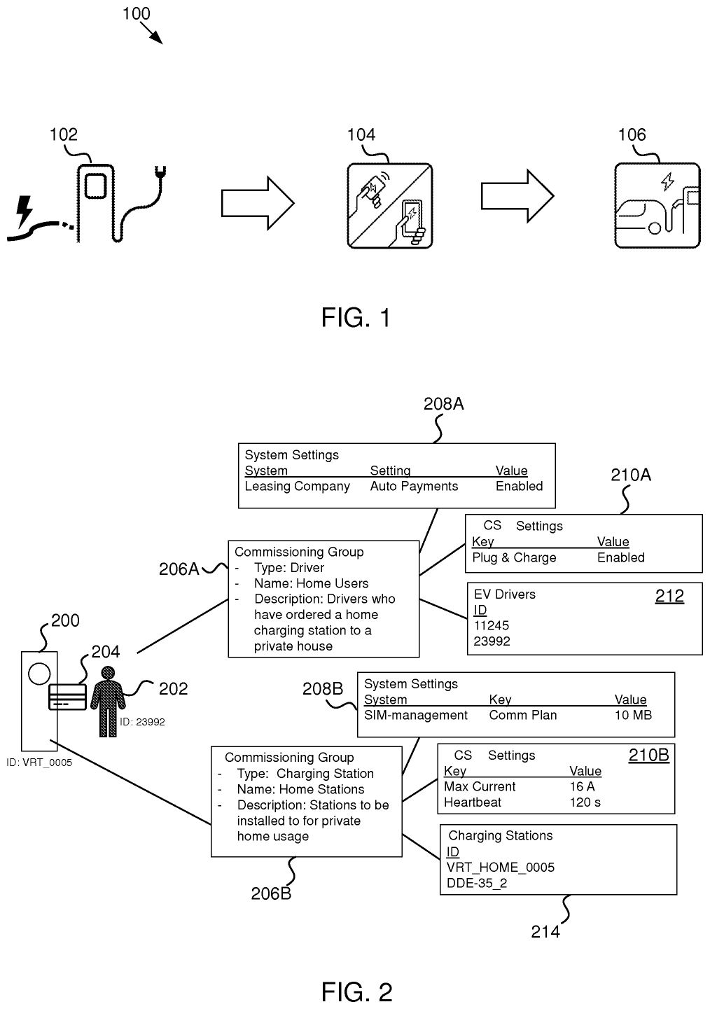

An example embodiment may enable significant reduction in the number of instructions needed to be followed by a person setting up a charging station by configuring an apparatus to perform at least some of commissioning processes automatically. As illustrated in FIG. 1, by automating at least some of the processes with the apparatus, the only steps the person may need to take may comprise connecting electricity to power on the home charging station having general (factory) settings pre-installed (operation 102) and showing a RFID-card or similar identifier of a user to the home charging station's RFID-reader or the like (operation 104). After the charging station has read the RFID-card for the first time, the apparatus may be configured to perform automatic configurations based on predetermined settings at operation 106. Hence, only the electrical installation and showing the RFID-card to the RFID-reader may need to be performed by a user to have a charging station ready to be used with right configurations.

An example embodiment may enable achieving at least some of the following results with commissioning of new home charging stations by the apparatus configured to perform the commissioning: the home charging station may be shown in a mobile application of a correct EV driver; a SIM-card (or other internet connectivity solution) in the home charging station may have correct settings (for example, a data package); one or more additional features (for example, plug & charge) may be enabled if the home charging station is used by just a single household; RFID-cards of allowed users may be whitelisted on the home charging station so that if the home charging station goes offline, the allowed users can still stop or start charging; if an EV driver is a fleet user (electricity paid by a fleet operator), the EV driver may automatically get charging compensated without extra settings required afterwards; if there are some other default settings (such as a maximum current), the settings may be set automatically for the home charging station. The apparatus may be configured to set at least one of the above settings automatically for the charging station when the user is identified for an initial charge. Hence, no additional user interaction with the charging station or a CSMS system may be required for commissioning.

Even though the charging station to be deployed may have some default factory commissioning settings, it may not yet be known which user is going to own the charging station, in what kind of a location the charging station will be used and what kinds of specific settings the charging station should have.

RFID-cards may be linked to an EV driver. When the EV driver registers a new account with an operator, the operator may provide them an RFID-card. Therefore, the apparatus may be configured to know which RFID-card belongs to which user based on an identifier of the RFID-card. In an embodiment, the apparatus may be configured to link both EV drivers and charging stations to a commissioning group. The commissioning group may be, for example, an EV driver commissioning group or a charging station commissioning group. A plurality of commissioning groups may be configured by the apparatus with different charging stations or EV drivers. Each commissioning group may have different default settings. When an EV driver shows their RFID-card to a new charging station, the apparatus may be configured to check if the respective charging station has already been commissioned. The apparatus may be configured to determine to which commissioning group the EV driver and the charging station belong if the commissioning configuration has not yet been performed. Based on the commissioning group(s), the apparatus may be configured to determine which default settings the commissioning groups have. After the apparatus has found the right configurations, the apparatus may be configured to send needed configurations to the charging station. In addition, needed configurations may be sent to one or more third party systems, for example, regarding SIM management.

FIG. 2 illustrates an example of data stored for commissioning of a new charging station 200 according to an example embodiment. The data may be stored at an apparatus configured for commissioning of charging stations.

At 206A and 206B, the data may comprise one or more commissioning groups. The commissioning group may comprise, for example, an indication of a type of the commissioning group such as an EV driver or a charging station. The commissioning group may further comprise a name of the commissioning group, such as “Home users” or “Home stations”. The commissioning group may comprise a description of the commissioning group. The description may be, for example “Drivers who have ordered a home charging station to a private house” or “Charging stations to be installed for private home usage”. Different settings (at 208A, 208B and 210A, 210B) may be linked to the commissioning group and the associated EV driver(s) and/or charging station(s) 200.

At 214, the data may comprise one or more charging stations linked to at least one of the commissioning groups. Data associated with the charging station(s) may comprise an identifier of one or more charging stations 200. For example, the data may comprise two charging stations having unique identifiers, such as VRT_HOME_0005 and DDE-35_2. The identifiers are only one example, and they may have any configured form, which may be determined by a manufacturer or operator of the charging station. Settings stored at 208B and 210B may be configured based on a received identifier of a charging station listed at 214. The data may further comprise an indication of whether commissioning is done (true/false) based on the settings at 208A, 208B and 210A, 210B.

At 212, the data may comprise one or more EV drivers linked to at least one of the commissioning groups. Data associated with the EV driver(s) may comprise an identifier of each EV driver. For example, the data may comprise identifiers of two EV drivers having unique identifiers, such as 11245 and 23992. These are only one example, and the identifiers may be in any configured form. The data may further comprise an identifier of a RFID-card of the respective EV driver. Settings stored at 208A and 210A may be configured by the apparatus based on an obtained identifier of an EV driver listed at 212. Each commissioning group may comprise a unique list of identifiers. The unique list of identifiers may comprise unique identifiers of at least one of the users of charging stations.

For example, when a user 202 shows their RFID-card 204 to a charging station 200 for the first time, the apparatus may be configured to obtain an identifier of the user 202 based on the identifier of the RFID card 204. The charging station 200 may be configured to send an authorization request to the apparatus after detecting the RFID-card 204. Based on the communication between the charging station 200 and the apparatus, the apparatus may be configured to obtain an identifier of the charging station 200 and the identifier of the RFID-card 204 associated with the authorization request. The apparatus may be then configured to check to which commissioning group the user 202 belongs. Based on the identifier of the charging station, the apparatus may be configured to check to which commissioning group the charging station 200 belongs. A commissioning group may refer to both EV driver based commissioning groups and charging station based commissioning groups.

At 208A and 208B, the data may comprise system settings associated with one or more commissioning groups. The system settings may comprise system information. The system information may indicate for which IT system the settings are meant. The system information may indicate, for example, that the settings are to be configured for a CSMS, an IT system of a leasing company or an IT system associated with SIM management. The system settings may further comprise setting information. The setting information may comprise, for example, settings to enable auto payments or a data communication plan for an indicated charging station. The setting information may comprise a value of specific settings indicating whether the setting is enabled or not for the associated commissioning group.

At 210A and 210B, the data may comprise charging station settings. The charging station settings may comprise a key. A key may indicate features configurable for the commissioning group. The feature may be, for example, an automatic authentication process such as a plug & charge feature, a maximum current for the charging station or a heartbeat interval for the charging station. The charging station settings may further comprise access settings. The access settings may comprise, for example, an authorization mode of the charging station 200 and/or one or more parameters for authorization. The charging station settings may further comprise a value of the key. A value of the key may be, for example, enabled or disabled depending on whether the feature is allowed to be configured for the respective commissioning group. The key may also have some numerical values. For example, the key associated with the heartbeat interval may comprise a value of 120 s to set the heartbeat interval accordingly at the charging station.

As previously described, when a user 202 shows an RFID-card 204 to a charging station 200, the charging station 200 may be configured to send an authorization request to the apparatus. The authorization request may comprise: 1) identifier of the charging station 200, 2) RFID card's identifier such as a number of the RFID-card 204.

The apparatus may be configured to find the right commissioning group (or groups) by checking: a) does the received identifier of the charging station 200 belong to any commissioning group? b) does the received identifier of the RFID-card 204 belong to any commissioning group?

Identifiers of the charging stations or RFIDs can also comprise wildcards. For example, all charging stations whose identifier starts with “VRT_HOME_*” may belong to a certain commissioning group (with similar identifiers such as VRT_HOME_001, VRT_HOME_002 etc.).

Each commissioning group may comprise certain settings that the apparatus may be configured to make automatically once the authorization request is received by the apparatus from a charging station or an EV driver. The apparatus may be configured to make the settings for at least one of: a) the charging station, or b) to an IT system. The IT system may comprise, for example, a CSMS or an external third party system the apparatus is communicatively coupled to. The third party system may comprise an IT (information technology) system of a service provider, such as a leasing company or a communications service provider.

For example, a charging station for home use may be provided to a user who has a company car from a leasing company. When the user orders the charging station, the user may be added to an EV driver commissioning group of home users stored on the apparatus as a part of processing of the order. The charging station may be shipped from a warehouse that has home charging stations. Further, the home charging stations may be added to a charging station-based commissioning group of home charging stations stored on the apparatus.

When a charging station is then installed and a user shows their RFID-card to the charging station, the apparatus may be able to perform one or more operations automatically. For example, the apparatus may be configured to update an IT system of the leasing company such that the user may be provided with automatic payments for electricity used at a home charging station based on the stored setting “automatic payments” at 208A enabled for the charging station. The apparatus may also be configured, for example, to update internal settings of the charging station to have automatic authorization (e.g., plug & charge) enabled (based on data stored in the EV driver commissioning group at 210A), a max charging current to be 16 A and a heartbeat interval to be 120 s (based on data stored in the charging station commissioning group at 210B). The apparatus may be configured to also update a SIM-management system to put a 10 MB data communication plan to the SIM-card in the charging station based on the stored data at 208B.

As a result, the apparatus may be configured to perform a plurality of configurations in different places in response to a received identifier. The user may only have to show the RFID-card to the charging station to initiate the configurations.

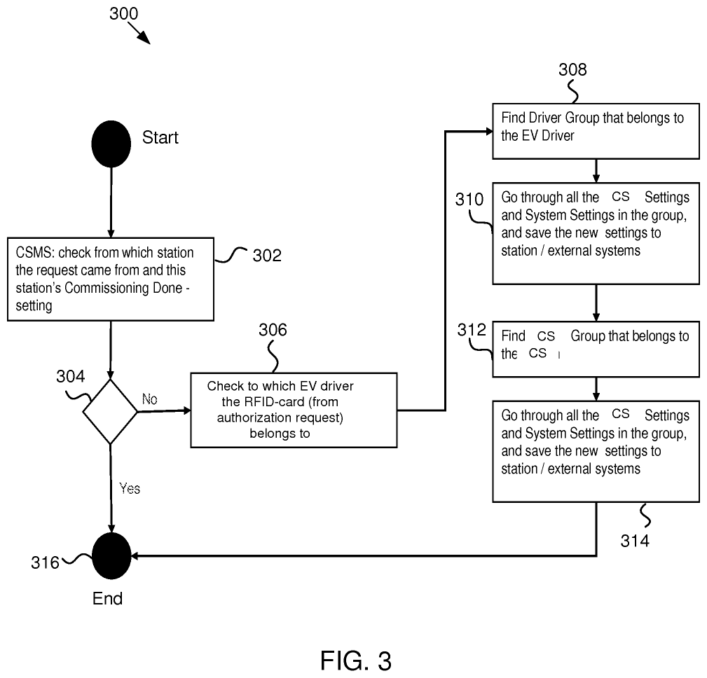

FIG. 3 illustrates an example of a method 300 for charging station commissioning according to an example embodiment. The method may be executed by an apparatus configured for commissioning of charging stations. Initially, a charging station may be electrically installed to a place of use and powered on. Thereafter, a user may identify themselves at the charging station, for example, by showing their RFID-card to a RFID-reader of the charging station. Consequently, the charging station may send an authorization request to a charging station management system. The authorization request may comprise both an identifier of the RFID-card and an identifier of the charging station sending the authorization request.

At an operation 302, the method may comprise checking from which charging station the authorization request was received from. Further, at an operation 304, the method may comprise checking a current setting of the respective charging station for commissioning, indicating whether the commissioning is already done or not. In case the setting for commissioning indicates that the commissioning for the charging station has not yet been performed, the method may proceed to an operation 306. If the setting indicates that the commissioning is already performed for the charging station, the method may proceed to an operation 316.

At the operation 306, the method may comprise cheking based on the authorization request to which EV driver the RFID-card belongs. The EV driver may be determined based on the identifier of the RFID-card and the associated identifier of a user. An identifier of a RFID-card and an identifier of a user may be referred to as an identifier associated to a user.

At an operation 308, the method may comprise determining to which EV driver-based commissioning group the EV driver belongs. The EV driver-based commissioning group may be determined based on a list of EV drivers of the commissioning group comprising the identifier of the user. The EV driver-based commissioning group may comprise parameters for user-specific settings, such as parameters to set an automatic authorization process, such as the plug & charge, to enable automatic payments from a leasing company or to add the user to a list of authorized users of a charging station.

At an operation 310, the method may comprise saving new settings to at least one of the charging station, a CSMS or one or more third party systems based on all stored charging station settings and system settings associated with the determined EV driver based commissioning group.

At an operation 312, the method may comprise determining to which charging station-based commissioning group the charging station belongs. The charging station-based commissioning group may be determined based on a list of charging stations of the commissioning group comprising the received identifier of the charging station.

At an operation 314, the method may comprise saving new settings to at least one of the charging station, the CSMS or one or more third party systems based on all stored charging station settings and system settings associated with the determined charging station-based commissioning group.

At an operation 316, the method may comprise continuing an authorization process as normally after the commissioning is done based on the operations 306-314. For example, in case the apparatus comprises the CSMS, the apparatus may process the authorization request for authorization. Alternatively, the apparatus may be configured to indicate to the CSMS that authorization based on the authorization request may be processed. The method may comprise changing the setting for commissioning accordingly from “false” to “true”. Hence, when another authorization request is received from the charging station, the operations 306-314 may not be repeated.

As described, there can be a variety of different settings that can be set automatically for charging stations or different third-party systems. In general, any configuration parameter which is supported by the respective charging station and by the communication protocol used between the charging station and the apparatus may be set. For example, if the charging station and the apparatus communicate with the OCPP protocol, any parameter that a ChangeConfiguration-message of the OCPP protocol supports can be used. Further, there may be some settings that need to be made to an internal configuration of the apparatus. As an example, a typical setting might be a plug & charge identifier. When plug & charge is enabled for a charging station, an individual identifier may need to be saved to an internal configuration of the CSMS. The apparatus may be connected to different third-party systems through APIs, for example. There may be a variety of different settings the third-party APIs support. As an example, a SIM-card management system may be a typical third-party system. The apparatus may automatically change a data communication plan setting of individual SIM-cards, depending for example on in which country the charging station is, or how much data is estimated for a certain group (like home charging stations) to typically use.

The above examples described a commissioning process where a plurality of configuration parameters may be set up for charging stations based on settings defined for an EV driver group and for a charging station group. The first performed commissioning process may be referred to as master commissioning. In addition, sub-commissioning of different parameters may be performed later, after the master commissioning has been done. The master commissioning may be also referred to as primary commissioning and the sub-commissioning as secondary commissioning.

An example use case for the sub-commissioning may be multi-home apartments, where several different users use the same charging stations, but where the access to the charging stations is wanted to be limited only to tenants of the building.

In case of such multi-home apartments, the master commissioning process may be performed by the apparatus when a first user shows a RFID-card to the charging station as previously described.

However, the apparatus may be configured to continue the commissioning process with sub-commissioning rules. For example, after the 2nd, 3rd etc. EV drivers have shown their RFID-card to the charging station, the apparatus may be configured to continue the commissioning process to give access for the subsequent users to the charging station, simply by showing their RFID-cards.

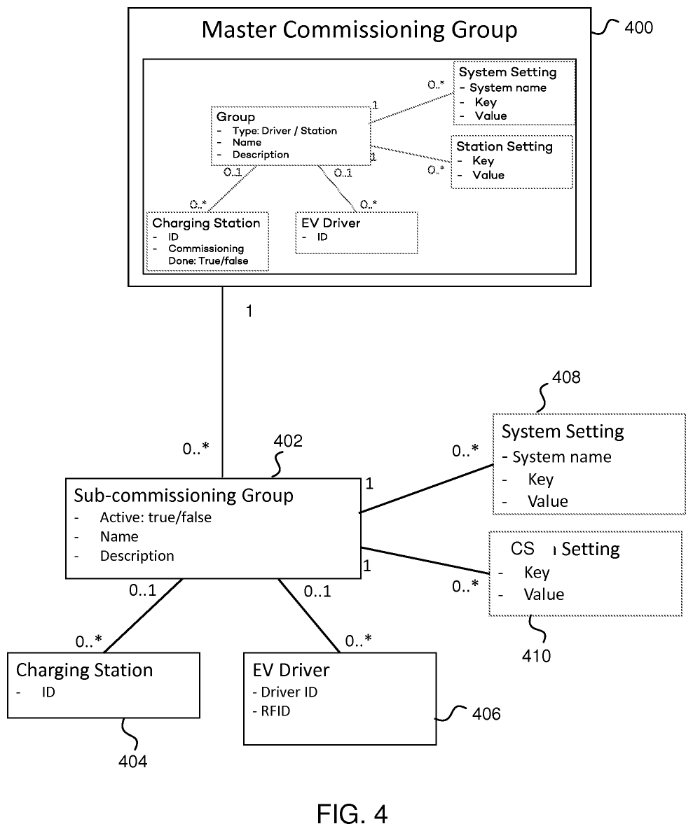

FIG. 4 illustrates an example of data stored for a sub-commissioning process according to an example embodiment. The data may be stored to an apparatus configured for commissioning of charging stations.

At 402, the data may comprise one or more sub-commissioning groups. Each sub-commissioning group may be associated to one master commissioning group 400. The master commissioning group 400 may comprise, for example, at least one of the commissioning groups 206A, 206B. The sub-commissioning group may comprise an indication of whether the sub-commissioning is activated. The sub-commissioning group may further comprise a name of the sub-commissioning group. The sub-commissioning group may comprise a description of the sub-commissioning group.

At 404, the data may comprise information on one or more charging stations associated with the sub-commissioning group. The data may comprise, for example, identifiers of the charging stations.

At 406, the data may comprise information on one or more users associated with the sub-commissioning group. The data may comprise, for example, identifiers of the users. The data may further comprise, for example, identifiers of RFID-cards. Each identifier of a RFID-card may be linked to one identifier of a user. Each sub-commissioning group may be associated with different identifiers of users and/or charging stations. Hence, each sub-commisioning group may comprise a unique list of identifiers.

At 408, the data may comprise charging station settings. The charging station settings may comprise one or more keys indicating which setting may be configured for the charging stations of the sub-commissioning group. The charging station setting may further comprise a value for the key.

At 410, the data may comprise system settings. The system settings may comprise, for example, the name of the system for which settings are to be performed. The system settings may comprise a key indicating which feature may be configured for the system(s). The system settings may further comprise a value for the key.

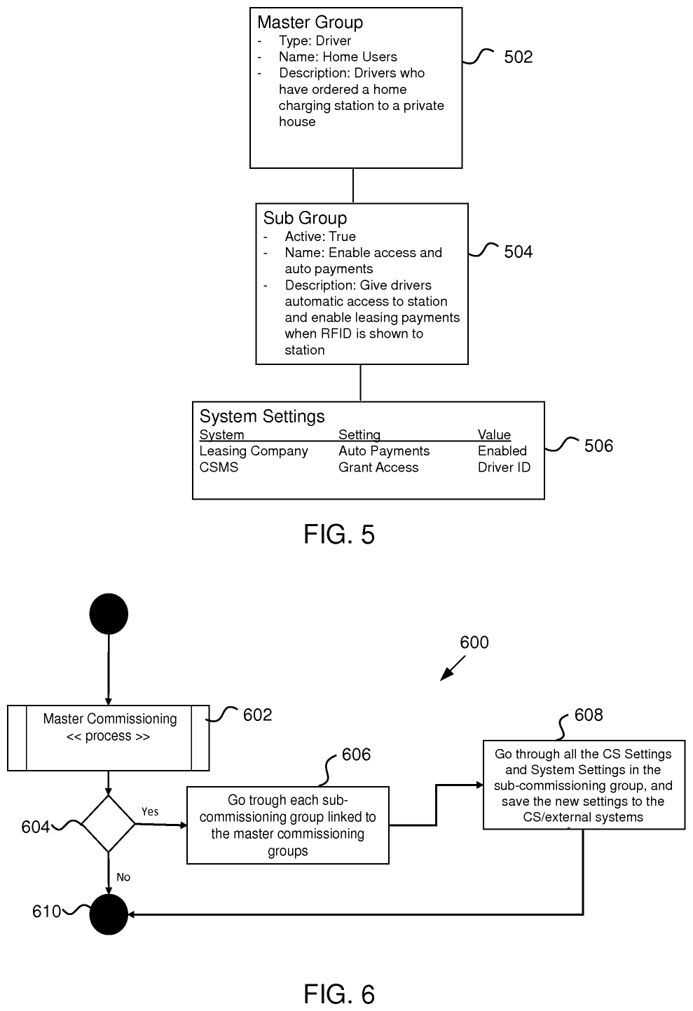

FIG. 5 illustrates an example of a configuration for sub-commissioning according to an example embodiment. The configurations may be performed by an apparatus configured for commissioning of charging stations.

At 502, the apparatus may be configured to perform configurations based on a master commissioning group. The master commissioning group may comprise at least one of a type, a name, or a description of the master commissioning group. The type of the master commissioning group may be, for example, EV drivers. The name of the master commissioning group may be, for example, home users. The description of the master commissioning group may be, for example, drivers who have ordered a home charging station to a private house.

At 504, the apparatus may be configured to perform configurations based on a sub-commissioning group. The sub-commissioning group may comprise at least one of an indication of whether the sub-commissioning group is activated, a name of the sub-commissioning group, or a description of the sub-commissioning group. The apparatus may be configured to activate the sub-commissioning group when an associated master commissioning process has been performed. The apparatus may configure the activation for a predetermined time period. The name of the sub-commissioning group may be descriptive of functions to be performed for the sub-commissioning group. The name may be, for example, “enable access and autopayments”. The description may give more details and be, for example, “give users automatic access to a charging station and enable leasing payments when a RFID is shown to the charging station”. However, the described content for the master and sub-commissioning groups is only an example.

At 506, the apparatus may be configured to perform configurations based on, for example, system settings. For example, the system settings may indicate two systems, such as a leasing company and a CSMS for which some dedicated settings may be configured. For example, based on the system settings, the apparatus may configure autopayments to be enabled for the leasing company. Further, the apparatus may configure an access to a charging station to be granted based on identifiers of users received while the sub-commissioning group is active.

FIG. 6 illustrates an example of a method 600 for sub-commissioning of charging stations according to an example embodiment. The method may be executed by an apparatus configured for commissioning of charging stations. The method may be initiated when a user has identified themselves at the charging station, for example, by showing their RFID-card to a RFID-reader of the charging station. Consequently, the charging station may send an authorization request to a charging station management system. The request may comprise both an identifier of the RFID-card and an identifier of the charging station sending the request.

At an operation 602, the method may comprise performing master commissioning according to FIG. 3.

At an operation 604, the method may comprise determining if there are active sub-commissioning groups. If active sub-commissioning groups are found, the method may proceed to an operation 606. If no active sub-commissioning groups are found, the method may proceed to an operation 610. If the master commissioning group is associated to a sub-commissioning group, it may be configured to be active for a predetermined time period, for example, after reception of the first authorization request. When a sub-commissioning group is associated to a master commissioning group, the sub-commissioning group may comprise at least one same identifier as the master group. If there are no associated sub-commissioning groups, or if the predetermined time period has elapsed, it may be determined that there are no currently active sub-commissioning groups.

At the operation 606, the method may comprise retrieving data on each active sub-commissioning group linked to the master commissioning group(s) of operation 602.

At an operation 608, the method may comprise retrieving data on each station setting and system setting in the active sub-commissioning group. The method may further comprise saving new settings to the charging station and/or indicated third party systems according to the retrieved data.

After the operations 602-608 have been performed, the method may comprise determining at the operation 610 that commissioning is done. When the commissioning is done, the authorization process according to a protocol used by the charging station may be continued.

In an example embodiment, there may be an apartment building with several tenants charging their EVs on the same charging stations. One or more charging stations may be shipped to the building with factory settings. A normal electrical installation may be done by an electrician for charging stations after they arrive. The electrical installation is to provide power to a charging station, so no settings may be made to the charging station, a CSMS, or to any other place at this point.

The apparatus may be configured to set a pre-determined time period for self-registration. Self-registration refers to a registration process of a user based on an identifier received from the user as an authorized user allowed to use one or more charging stations. For example, after the electrical installation has been done, tenants of the building may have the predetermined time period configured by the apparatus, for example two days after the sub-commissioning group is set active, to do a first charge using their RFID-card. During the procedure to start the first charge by showing the RFID-card to a reader of a charging station, the apparatus may be configured to add the tenants as authorized persons who are allowed to use the charging stations. Hence, the procedure for the first charge comprises self-registration in the background such that no additional inputs from a user may be required. Also, the apparatus may be configured to set necessary settings for the charging station and/or for the CSMS system automatically based on the identifiers received by the apparatus when the users identify themselves at the charging station.

After the two days, the apparatus may be configured to close the self-registration as the sub-commissioning group is no longer active due to the elapsed predetermined time period. Only the authorized tenants may then use the charging stations. However, more access rights can be given later in the CSMS system, for example.

In general, a process of registering authorized users and configuring new settings for a charging station would require a lot of manual work by making different settings for charging stations, for a CSMS system and associated third party systems. An example embodiment enables an automatic commissioning process which may enable performing at least part of a commissioning process automatically by an apparatus, where just an electrical installation and showing a RFID-card to the charging station may be needed from a user.

In an embodiment, at the operation 602, the apparatus may be configured to perform the following configurations based on a master commissioning group. Charging station settings stored at the apparatus may comprise a heartbeat interval having a value of, for example, 120 seconds. The charging station settings may further comprise a maximum current which may have a value of, for example, 16 A. System settings may comprise settings for a CSMS system for configuring authorization to be public, for example, for the predetermined time period of self-registration. Accordingly, the apparatus may be configured to set one or more associated sub-commissioning groups active for the predetermined time period.

In an embodiment, at the operation 608, the apparatus may be configured to perform configurations for sub-commissioning. For example, the system settings stored at the apparatus may comprise configurations for the CSMS system, such as setting authorized users based on an identifier of the user who showed the RFID-card to the charging station.

The next example illustrates how the automatic commissioning may be performed by the apparatus based on the configuration settings at the operations 602 and 608. When a first tenant shows their RFID-card to a charging station, the apparatus may be configured to automatically send the correct settings retrieved at 602 (120 s heartbeat and 16 A maximum current) to the charging station and set authorization as public. The apparatus may be also configured to add the first tenant (=EV driver or user) to an authorized user list.

When a second tenant shows their RFID-card, the master commissioning may be already done by the apparatus. Hence, the master commissioning process may not be repeated. However, based on a sub-commissioning rule at the operation 608, the second tenant may also be added by the apparatus to the authorised user list. Similarly, the apparatus may be configured to add a third, a fourth etc. tenant showing their RFID-cards at the charging station during the predetermined time period for self-registration to the authorized user list.

After the predetermined time period for self-registration is over, the apparatus may be configured to update the authorization setting of the CSMS system from public to private. This means that when new people who are for example not the tenants of the building try to use the charging station, their access may be denied. However, the tenants who showed their RFID-card to the charging station during the predetermined time period for self-registration may continue using the charging station normally.

In another example, it may be assumed that the setup described in the above example is done. The charging station may be located at a multi-tenant building and a commissioning where only the tenants are allowed to charge on the charging station is done by the apparatus. Later, the charging station may start to have problems. A maintenance person may be called to check what is wrong with the charging station. However, since the maintenance person is not a tenant of the building, they may not be able to test how the charging station works, since all their attempts to use the charging station may be rejected.

For example, access to a charging station may be enabled for some users, such as maintenance personnel. Maintenance personnel may have two RFID-cards: a RFID-card configured for a maintenance mode and a RFID-card configured for a normal mode. Once a maintenance person arrives at the charging station, they may show the RIFD-card configured for the maintenance mode to the charging station. When the respective RFID-card is shown to the charging station, the apparatus may be configured to cause changes on settings on the charging station and on the CSMS so that the maintenance person may be able to do different testing procedures on the charging station freely. Once the maintenance work is done by the maintenance person and the problem may be fixed, the maintenance person may show the RFID-card configured for normal mode to the charging station. After the respective RFID-card has been shown to the charging station, the apparatus may be configured to cause the charging station to return to a normal operating mode.

Without the use of the two RFID-cards for the maintenance personnel and associated configurations performed by the apparatus, a lot of manual settings in the CSMS system would be required to enable the maintenance work. With the two types of RFID-cards and the associated configurations by the apparatus, the maintenance work may be performed in a faster and easier manner.

Charging stations and especially software running inside a charging station may create different log files that include detailed information on what has been happening inside the charging station. A logging method may comprise separating individual log entries to different levels comprising, for example, a debug level, an info level, an alert level, or an error level. Since log files can be really big, a typical practice may be to limit what things are written to log files. A setup may comprise, for example, that only alerts and errors are saved to log files, but other entries the software might write are not saved to log files. When there is a problem on a charging station, it may be useful to get as detailed information as possible on what causes the problem. If a charging station logs for example only error-level entries, a maintenance person might only see an error message like “Charging Failed”, but no reason why it failed. In this case it may be useful to temporarily enable the debug-logging level where the charging station may be caused to write detailed entries to the log file on what happened before the error happened. This may enable to find out the cause of the problem. However, the debug-level logging may not be wanted to be always on, since it might create huge log files that may fill a memory space.

The commissioning may comprise the following configurations to be performed by the apparatus to enable the maintenance mode. The apparatus may be configured to perform configurations associated to a master commissioning group as described earlier. The apparatus may comprise data on the master commissioning group and associated with a sub-commissioning group for a maintenance mode. The data on the sub-commissioning group for the maintenance mode may comprise a list of RFID-cards configured for maintenance personnel. The list may comprise identifiers of the configured RFID-cards, such as A1B2C3, D1E2F3 and AAB3C6E3, for example. The sub-commissioning group for the maintenance mode may comprise system settings for CSMS, wherein the authorization mode is set to public, and a logging level is set to debug. A public authorization mode refers to a mode where access is granted to any user. For example, when the authorization mode of the charging station is set to public, the charging station may be shown in a mobile application for all users and there may be no restrictions on which EV driver can access and use the charging station.

The data on the master commissioning group may be further associated with a further sub-commissioning group for a normal mode. The data on the sub-commissioning group for the normal mode may comprise a list of RFID-cards configured for the maintenance personnel. The identifiers of the RFID-cards may be different than for the maintenance mode. The identifiers may be, for example, DDE4F6, E3AAB5 and CA5AB8. The data on the sub-commissioning group for the normal mode may comprise system settings for CSMS. Based on the system settings for CSMS, the apparatus may be configured to set an authorization mode to private, and a logging level to normal. A private authorization mode refers to a mode where access is only granted to specific users. When the charging mode of a charging station is set to private, only certain EV drivers who are given access to the charging station may use it. For example, the charging station having a private authorization mode may not be visible for all users in the mobile application and not all EV drivers may be authorized to charge there. Only the EV drivers who may be separately given access to the charging station can see it in the mobile application and charge their EV at the charging station. The access permissions may be managed by a CSMS.

For example, a maintenance person may show an RFID-card that belongs to a sub-commissioning group for the maintenance mode to a charging station. The apparatus may receive a message from the charging station comprising an identifier of the RFID-card. The apparatus may be then configured to check if the identifier belongs to any commissioning group. After finding the right commissioning group, the apparatus may be configured to check what settings belong to that commissioning group.

For example, there may be at least two settings in the commissioning group that the apparatus is configured to make. The settings may comprise configuring, by the apparatus, the authorization mode of the charging station to public, which means that the maintenance person may be able to use the charging station which otherwise would have restricted access. The apparatus may be also configured to set the logging level of the charging station to a more detailed debug level, which enables the maintenance person to get more detailed logs of the problem. Parameters to set the authorization mode of the charging station to private or public, and to set the logging level of the charging station to a debug-level or a normal level may be referred to as user-specific settings.

After the maintenance work has been done, the maintenance person may show another RFID-card to the charging station that belongs to a sub-commissioning group for the normal mode. Again, the apparatus may be configured to check settings of the respective sub-commissioning group and perform the settings. The settings may comprise returning the authorisation from public to private and the logging level back to normal from the debug level. The normal logging level may comprise, for example, the error level, the error level or the info level, where less detailed logs are saved by the software of the charging station.

Different public charging stations may need different settings, for example depending on their location or a type of the charging station. As an example, a fast DC charging station in a busy premium location in a big city may need different settings than an AC charging station in a smaller city. All charging stations (AC and DC) may be shipped to the site with default factory commissioning settings. For example, installation personnel in different cities may have some dedicated RFID-cards they use after they have done the electrical installation of the charging station. A person doing DC charging station installations in a city A may have one RFID-card linked to commissioning settings of the city A. Another person installing AC charging stations in a city B may have another RFID-card linked to the commissioning settings in the city B. Once the person has done the electrical installation, as a final step the person may show the RFID-card to the charging station. When a message comprising the identifier of the RFID-card is received by the apparatus, the apparatus may be configured to perform correct commissioning settings based on the received identifier. As a result, the charging stations in different locations may have different settings without requiring anybody to do any manual setting work in an associated CSMS system.

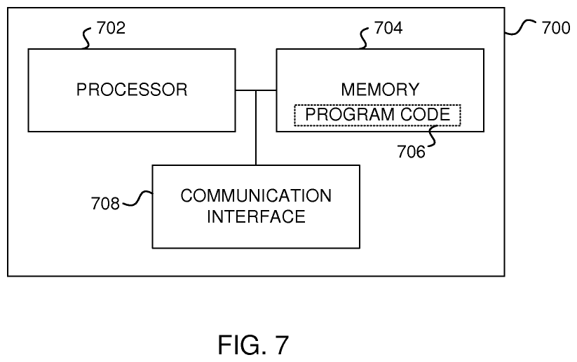

FIG. 7 illustrates an example of an apparatus 700 configured to practice at least one example embodiment. The apparatus 700 may be configured for commissioning of charging stations.

The apparatus 700 may comprise at least one processor 702. The at least one processor 702 may comprise, for example, one or more of various processing devices, such as for example a co-processor, a micro-processor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 700 may further comprise at least one memory 704. The memory 704 may be configured to store, for example, computer program code 706 or the like, for example operating system software and application software. The memory 704 may be configured to store at least part of data illustrated in FIG. 2 and FIG. 4. The memory 704 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 700 may further comprise a communication interface 708 configured to enable the apparatus 700 to transmit information to other devices and/or receive information from other devices. For example, the apparatus 700 may be configured to receive and transmit data from/to at least one of charging stations, a CSMS or an IT system. The data may comprise at least one of identifiers or configuration messages and third party systems. The communication interface 708 may be configured to provide at least one wireless radio connection, such as for example a 3GPP mobile broadband connection (e.g., 3G, 4G, 5G). However, the communication interface 708 may be configured to provide one or more other types of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 708 may comprise, or be configured to be coupled to, at least one antenna to transmit and/or receive radio frequency signals. One or more of the various types of connections may be also implemented as separate communication interfaces, which may be coupled or configured to be coupled to a plurality of antennas. The apparatus 700 may further comprise a user interface comprising an input device and/or an output device.

The apparatus 700 may comprise for example a server device, a client device, a mobile phone, a tablet computer, a laptop, or the like. In an embodiment, the apparatus 700 may comprise a CSMS. The apparatus may be cloud-based. Hence, the apparatus 700 may comprise applications, services or resources made available to users on demand via the Internet from (a) cloud computing server(s). Although the apparatus 700 is illustrated as a single device it is appreciated that, wherever applicable, functions of the apparatus 100 may be distributed to a plurality of devices.

When the apparatus 700 is configured to implement some functionality, some component and/or components of the apparatus 700, such as for example the at least one processor 702 and/or the memory 704, may be configured to implement this functionality. Furthermore, when the at least one processor 702 is configured to implement some functionality, this functionality may be implemented using program code 706 comprised, for example, in the memory 704.

The functionality described herein may be performed, at least in part, by one or more computer program product components such as software components. According to an embodiment, the apparatus 700 comprises a processor 702 or processor circuitry, such as for example a microcontroller, configured by the program code 706 when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), application-specific Integrated Circuits (ASICs), application-specific Standard Products (ASSPs), System-on-a-chip systems (SOCs), Complex Programmable Logic Devices (CPLDs), Graphics Processing Units (GPUS).

The apparatus 700 comprises means for performing at least one method described herein. As one example, the means comprises the at least one processor 702, the at least one memory 704 including instructions which, when executed by the at least one processor 702, cause the apparatus 700 to perform the method.

It is obvious to a person skilled in the art that with the advancement of technology, the basic idea of the invention may be implemented in various ways. The invention and its embodiments are thus not limited to the examples described above; instead, they may vary within the scope of the claims.

The apparatus 700 may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at least one memory and the program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firm-ware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. An apparatus for commissioning of charging stations, the apparatus comprising:
at least one processor; and
at least one memory comprising instructions which, when executed by the at least one processor cause the apparatus to:
store a plurality of commissioning groups, each commissioning group comprising information on different settings for configuring at least one of a charging station, a charging station management system or one or more third party systems associated with the charging station and a unique list of identifiers;
receive an authorization request from a charging station, the authorization request comprising a unique identifier of the charging station and a unique identifier associated to a user;
determine if the identifier of the charging station belongs to the unique list of identifiers of any of the plurality of commissioning groups;
determine if the identifier associated to the user belongs to the unique list of identifiers of any of the plurality of commissioning groups;
determine, based on at least one commissioning group comprising the identifier of the charging station or the identifier associated to the user, which settings are to be performed and where for automatic commissioning; and
perform commissioning of the charging station which sent the authorization request by configuring at least one of the charging station which sent the authorization request, the charging station management system or the one or more third party systems according to the determined settings.

2. The apparatus of claim 1, wherein the at least one memory further comprises instructions which, when executed by the at least one processor, cause the apparatus to:
store at least one sub-commissioning group, wherein each sub-commissioning group is associated to one commissioning group and comprises further settings for configuring at least one of the charging station, the charging station management system or the one or more third party systems and at least one identifier from the unique list of identifiers of the commissioning group;
activate the at least one sub-commissioning group for a predetermined time period after the configuration according to the associated commissioning group has been performed by setting an authorization mode of the charging station which sent the authorization request to public for the predetermined time period;
receive an authorization request within the predetermined time period comprising the identifier of the charging station and another identifier associated to a user; and
configure at least one of the charging station which sent the authorization message, the charging station management system or the one or more third party systems according to the settings of the at least one sub-commissioning group.

3. The apparatus of claim 2, wherein the at least one memory further comprises instructions which, when executed by the at least one processor cause the apparatus to:
determine if the charging station which sent the authorization request has been previously configured according to the settings of at least one associated commissioning group;
determine if the at least one commissioning group is associated to at least one sub-commissioning group;
determine if the at least one sub-commissioning group has been previously activated and that the predetermined time period has elapsed; and
cause an authorization process to continue based on the authorization request if the configurations based on at least one of the commissioning group or the sub-commissioning group have been already done.

4. The apparatus of claim 1, wherein the one or more third party systems comprise at least one of a management system of a leasing company or an internet connectivity solution management system.

5. The apparatus of claim 1, wherein the unique list of identifiers comprises at least one identifier associated with a user and the settings of the respective commissioning group or sub-commissioning group comprise parameters to set at least one user-specific setting at least one of at the charging station, the charging station management system or the one or more third party systems.

6. The apparatus of claim 1, wherein the unique list of identifiers comprises an identifier of at least one charging station and the settings of the respective commissioning group or sub-commissioning group comprise parameters to at least one of set a maximum current of the charging station, set a heartbeat interval of the charging station, update a data communication plan of an internet connectivity solution at the charging station, set the authorization mode at the charging station to public or set the authorization mode at the charging station to private.

7. The apparatus of claim 2, wherein the at least one identifier associated to a user of at least one sub-commissioning group is associated with maintenance personnel and the settings comprise parameters to at least one of set an authorization mode at a charging station to public, set the authorization mode at a charging station to private, set a logging level of a charging station to a debug level for maintenance or set the logging level of a charging station to a normal level; and wherein
the at least one memory further comprises instructions which, when executed by the processor cause the apparatus to:
receive an authorization request from the charging station after the predetermined time period has elapsed, the authorization request comprising the identifier of the charging station and an identifier associated to a user;
determine if the identifier associated with the user is comprised in the sub-commissioning group associated with the maintenance personnel; and
configure the charging station which sent the authorization request and the charging station management system according to the settings of the sub-commissioning group.

8. A method for commissioning of a charging station, the method comprising:
storing a plurality of commissioning groups, each commissioning group comprising information on different settings for configuring at least one of a charging station, a charging station management system or one or more third party systems associated with the charging station and a unique list of identifiers;
receiving an authorization request from a charging station, the authorization request comprising a unique identifier of the charging station and a unique identifier associated to a user;
determining if the identifier of the charging station belongs to the unique list of identifiers of any of the plurality of commissioning groups;
determining if the identifier associated to the user belongs to the unique list of identifiers of any of the plurality of commissioning groups;
determining, based on the at least one commissioning group comprising the identifier of the charging station or the identifier associated to the user, which settings are to be performed and where for automatic commissioning; and
performing commissioning of the charging station which sent the authorization request by configuring at least one of the charging station which sent the authorization request, the charging station management system or the one or more third party systems according to the determined settings.

9. The method of claim 8, further comprising:
storing at least one sub-commissioning group, wherein each sub-commissioning group is associated to one commissioning group and comprises further settings for configuring at least one of the charging station, the charging station management system or the one or more third party systems and at least one identifier from the unique list of identifiers;
activating a configuration according to the at least one sub-commissioning group for a predetermined time period after the configuration according to the associated commissioning group has been performed by setting an authorization mode of the charging station which sent the authorization request to public for the predetermined time period;
receiving an authorization request from the charging station within the predetermined time period comprising the identifier of the charging station and another identifier associated to a user; and
configuring at least one of the charging station which sent the authorization message, the charging station management system or the one or more third party systems according to the settings of the at least one sub-commissioning group.

10. The method of claim 9, comprising:
determining if the charging station which sent the authorization request has been previously configured according to the settings of at least one associated commissioning group;
determining if the at least one commissioning group is associated to at least one sub-commissioning group;
determining if the at least one sub-commissioning group has been previously activated and that the predetermined time period has elapsed; and
causing an authorization process to continue based on the authorization request if the configurations based on at least one of the commissioning group or the sub-commissioning group have been already done.

11. The method of claim 8, wherein the unique list of identifiers comprises at least one identifier associated with a user and the settings of the respective commissioning group or sub-commissioning group comprise parameters to set at least one user-specific setting at least one of at the charging station, the charging station management system or the one or more third party systems.

12. The method of claim 8, wherein the unique list of identifiers comprises at least one identifier of a charging station and the settings of the respective commissioning group or sub-commissioning group comprise parameters to at least one of set a maximum current of the charging station, set a heartbeat interval of the charging station, update a data communication plan of an internet connectivity solution at the charging station, set the authorization mode at the charging station to public or set the authorization mode at the charging station to private.

13. The method of claims wherein the at least one identifier associated with a user of at least one sub-commissioning group is associated with maintenance personnel and the settings comprise parameters to at least one of set the authorization mode at a charging station to public, to set the authorization mode at a charging station to private, set a logging level of a charging station to a debug level for maintenance or set a logging level of a charging station to a normal level; and
the method further comprises receiving an authorization request from the charging station after the predetermined time period has elapsed, the authorization request comprising the identifier of the charging station and an identifier associated to a user;
determining if the identifier associated with the user is comprised in the sub-commissioning group associated with the maintenance personnel; and
configuring the charging station which sent the authorization request and the charging station management system according to the settings of the sub-commissioning group.

14. (canceled)

15. A computer readable medium comprising instructions which, when executed by a computer, cause the computer to carry out the method of claim 8.
